(19) United States
(12) Patent Application Publication
(10) Pub. No.: US 2025/0068712 A1
(43) Pub. Date: Feb. 27, 2025

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Tetsuro HOSHINO, Tokyo (JP)

(73) Assignee: NEC Corporation, Minato-ku, Tokyo (JP)

(21) Appl. No.: 18/722,631

(22) PCT Filed: Dec. 24, 2021
(86) PCT No.: PCT/JP2021/048209

§ 371 Date: Jun. 21, 2024

(51) Int. Cl. G06F 21/32; G06F 21/16

(52) U.S. Cl. CPC G06F 21/32; G06F 21/16

(57) ABSTRACT

An information processing system includes: a feature quantity acquisition unit that acquires biometric information about a target; a watermark generation unit that generates a digital watermark on the basis of the biometric information; an audio acquisition unit that acquires audio data including speech of the target; and a watermarking unit that adds the digital watermark to the audio data. According to such an information processing system, it is possible to prevent fraud/misconduct such as falsification of the audio data, for example.

### TECHNICAL FIELD

This disclosure relates to technical fields of an information processing system, an information processing method, a recording medium, and a data structure.

### BACKGROUND ART

Ear acoustic authentication or otoacoustic authentication is known for a kind of biometric authentication. For example, Patent Literature 1 discloses a technique/technology of: outputting a test signal from an audio device worn on the ear of a target; and acquiring, from a reverberation sound thereof, a feature quantity relating to an ear canal of the target.

Furthermore, there is known a technique/technology of detecting falsification/alteration of recorded audio data. For example, Patent Literature 2 discloses a technique/technology of verifying the falsification of conversation data, by adding an electronic signature or certificate with a public key, to the audio data.

### CITATION LIST

### Patent Literature

Patent Literature 1: International Publication No. WO2021/130949
Patent Literature 2: JP2002-230203A

### SUMMARY

### Technical Problem

This disclosure aims to improve the techniques/technologies disclosed in Citation List.

### Solution to Problem

An information processing system according to an example aspect of this disclosure includes: a feature quantity acquisition unit that acquires biometric information about a target; a watermark generation unit that generates a digital watermark on the basis of the biometric information; an audio acquisition unit that acquires audio data including speech of the target; and a watermarking unit that adds the digital watermark to the audio data.

An information processing method according to an example aspect of this disclosure includes: acquiring biometric information about a target; generating a digital watermark on the basis of the biometric information; acquiring audio data including speech of the target; and adding the digital watermark to the audio data.

A recording medium according to an example aspect of this disclosure is a recording medium on which a computer program that allows at least one computer to execute an information processing method is recorded, the information processing method including: acquiring biometric information about a target; generating a digital watermark on the basis of the biometric information; acquiring audio data including speech of the target; and adding the digital watermark to the audio data.

A data structure according to an example aspect of this disclosure is a data structure of audio data acquired by an audio device, the data structure including: metadata including personal information about a speaker of the audio data and time information about data creation; speech information about speech content of the speaker; biometric authentication information indicating that authentication is performed by using biometric information about the speaker in the audio device; device information about the audio device; a timestamp created on the basis of the metadata, the speech information, the biometric authentication information, and the device information; and an electronic signature created on the basis of the metadata, the speech information, the biometric authentication information, the device information, and the timestamp.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation by the information processing system according to the first example embodiment.

FIG. 4 is a sequential diagram illustrating an example of recording processing by the information processing system according to the first example embodiment.

FIG. 5 is a sequential diagram illustrating an example of reproduction processing by the information processing system according to the first example embodiment.

FIG. 6 is a conceptual diagram illustrating an example of a data structure of audio data handled by the information processing system according to the first example embodiment.

FIG. 7 is a block diagram illustrating a functional configuration of an information processing system according to a second example embodiment.

FIG. 8 is a flowchart illustrating a flow of operation by the information processing system according to the second example embodiment.

FIG. 9 is a block diagram illustrating a functional configuration of an information processing system according to a third example embodiment.

FIG. 10 is a conceptual diagram illustrating an example of authentication processing by the information processing system according to a third example embodiment.

FIG. 11 is a block diagram illustrating a functional configuration of an information processing system according to a fourth example embodiment.

FIG. 12 is a flowchart illustrating a flow of operation by the information processing system according to the fourth example embodiment.

FIG. 13 is a flowchart illustrating a flow of a search operation by the information processing system according to the fourth example embodiment.

FIG. 14 is a block diagram illustrating a functional configuration of an information processing system according to a fifth example embodiment.

FIG. 15 is a diagram illustrating an example of a seek bar displayed in the information processing system according to the fifth example embodiment.

FIG. 16 is a block diagram illustrating a functional configuration of an information processing system according to a sixth example embodiment.

FIG. 17 is version 1 of a diagram illustrating an example of a seek bar displayed in the information processing system according to the sixth example embodiment.

FIG. 18 is version 2 of a diagram illustrating an example of the seek bar displayed in the information processing system according to the sixth example embodiment.

FIG. 19 is a block diagram illustrating a functional configuration of an information processing system according to a seventh example embodiment.

FIG. 20 is a flowchart illustrating a flow of operation by the information processing system according to the seventh example embodiment.

FIG. 21 is a flowchart illustrating a flow of a reproduction operation by the information processing system according to the seventh example embodiment.

FIG. 22 is a block diagram illustrating a functional configuration of an information processing system according to an eighth example embodiment.

FIG. 23 is a flowchart illustrating a flow of operation by the information processing system according to the eighth example embodiment.

### DESCRIPTION OF EXAMPLE EMBODIMENTS

Hereinafter, an information processing system, an information processing method, a recording medium, and a data structure according to example embodiments will be described with reference to the drawings.

### First Example Embodiment

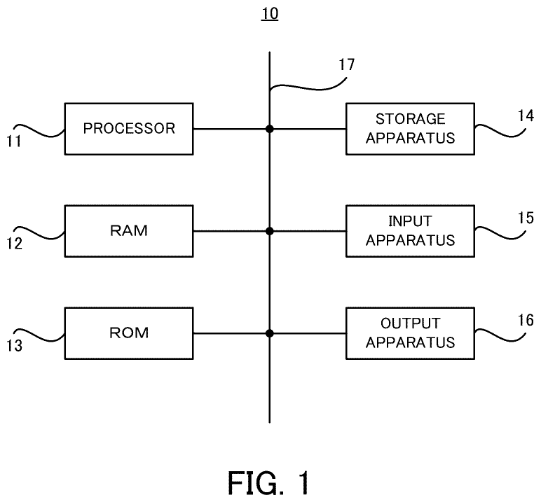

An information processing system according to a first example embodiment will be described with reference to FIG. 1 to FIG. 6.

### Hardware Configuration

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for adding a digital watermark to audio data, is realized or implemented in the processor 11. That is, the processor 11 may function as a controller for executing each control of the information processing system 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores the data that are stored for a long term by the information processing system 10. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example. The input apparatus 15 may also be configured as a hearable device used by the user putting it in the ear.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker device or the like that is configured to audio-output the information about the information processing system 10. The output apparatus 16 may be configured as a portable terminal such as a smartphone and a tablet. The output apparatus 16 may be an apparatus that outputs information in a form other than an image. For example, the output apparatus 16 may be a speaker device that audio-outputs the information about the information processing system 10. The output apparatus 15 may also be configured as a hearable device used by the user putting it in the ear.

Of the hardware described in FIG. 1, a part of the hardware may be provided in an apparatus other than the information processing system 10. For example, the information processing system 10 may include only the processor 11, the RAM 12, and the ROM 13, and the other components (i.e., the storage apparatus 14, the input apparatus 15, and the output apparatus 16) may be provided in an external apparatus connected to the information processing system 10, for example. Furthermore, in the information processing system 10, a part of an arithmetic function may also be realized by an external apparatus (e.g., an external server or cloud, etc.).

### Functional Configuration

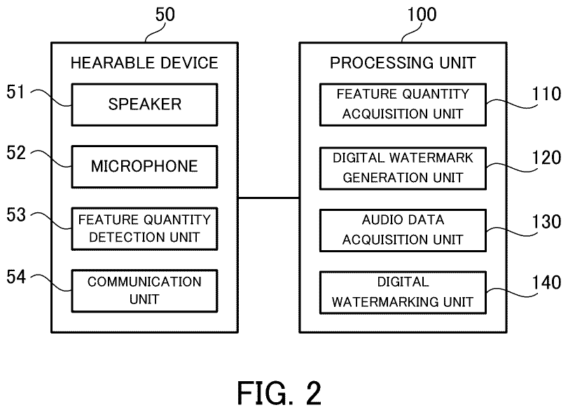

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment includes a hearable device 50 and a processing unit 100. The hearable device 10 is a device (e.g., an earphone type device) used by the user putting it in the ear, and is configured to audio-input and audio-output. The hearable device 50 here is used to acquire biometric information about a target, and may be replaced with another device that is configured to acquire the biometric information. The processing unit 100 is configured to perform various types of processing in the information processing system 10. The hearable device 50 and the processing unit 100 are configured to transmit/receive information with each other.

The hearable device 50 includes, as components for realizing the functions thereof, a speaker 51, a microphone 52, a feature quantity detection unit 53, and a communication unit 54.

The speaker 51 is configured to be outputting voice/sound/audio to the target wearing the hearable device 50. The speaker 51 outputs audio corresponding to audio data to be reproduced by the device, for example. In addition, the speaker 51 is configured to output a reference sound for detecting a feature quantity of an ear canal of the target. A plurality of speakers 51 may be also provided.

The microphone 52 is configured to acquire voice/sound/audio around the target wearing the hearable device 50. For example, the microphone 52 is configured to acquire speech/voice spoken by the target. The microphone 52 is also configured to acquire a reverberation sound (i.e., a sound obtained by reverberating the reference sound emitted by the speaker 51 in the ear canal of the target) for detecting the feature quantity of the ear canal of the target. A plurality of microphones 52 may be also provided.

The feature quantity detection unit 53 is configured to detect the feature quantity of the ear canal of the target, by using the speaker 51 and the microphone 52. Specifically, the feature quantity detection unit 53 outputs the reference sound from the speaker 51, and acquires the reverberation sound by the microphone 52. Then, the feature quantity detection unit 53 detects the feature quantity of the ear canal of the target by analyzing the acquired reverberation sound. The feature quantity detection unit 53 may be configured to perform authentication processing (i.e., ear acoustic authentication processing) using the detected feature quantity of the ear canal. Since a specific method of the ear acoustic authentication can employ the existing techniques/technologies as appropriate, a detailed description thereof will be omitted here.

The communication unit 54 is configured to transmit and receive various types of data, by communication between the hearable device 50 and other apparatuses. The communication unit 54 is configured to communicate with the processing unit 100. The communication unit 54 may be capable of outputting the voice/sound/audio acquired by the microphone 52, to the processing unit 100, for example. The communication unit 54 may be capable of outputting the feature quantity of the ear canal detected by the feature quantity detection unit 54, to the processing unit 100.

The processing unit 100 includes, as components for realizing the functions thereof, a feature quantity acquisition unit 110, a digital watermark generation unit 120, an audio data acquisition unit 130, and a digital watermarking unit 140. Each of the feature quantity acquisition unit 110, the digital watermark generation unit 120, the audio data acquisition unit 130, and the digital watermarking unit 140 may be a functional block realized or implemented by the processor 11 (see FIG. 1), for example.

The feature quantity acquisition unit 110 is configured to acquire the feature quantity of the ear canal of the target detected by the feature quantity detection unit 53 in the hearable device 50. That is, the feature quantity acquisition unit 110 is configured to acquire data about the feature quantity of the ear canal transmitted through the communication unit 54 from the feature quantity detection unit 53.

The digital watermark generation unit 120 generates a digital watermark from the feature quantity of the ear canal of the target acquired by the feature quantity acquisition unit 110 (in other words, the feature quantity detected by the feature quantity detection unit 53). The digital watermark is generated as what is capable of preventing unauthorized data copy or falsification/alteration. A method of generating the digital watermark here is not particularly limited.

The audio data acquisition unit 130 is configured to acquire audio data including speech of the target. For example, the audio data acquisition unit 130 acquires data on the voice/sound/audio acquired by the microphone 52 in the hearable device 50. The audio data acquisition unit 130, however, may acquire audio data acquired by a terminal other than the hearable device 50. For example, the audio data acquisition unit 130 may acquire audio data from a smartphone owned by the target.

The digital watermarking unit 140 is configured to add (embed) the digital watermark generated by the digital watermark generation unit 120, to the audio data acquired by the audio data acquisition unit 130. In this way, the digital watermark generated on the basis of the feature quantity of the ear canal of the target, is added to the audio data including the speech of the target.

### Flow of Operation

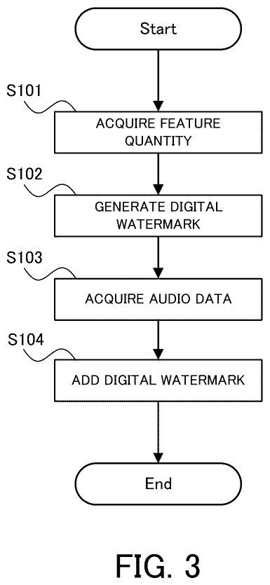

Next, with reference to FIG. 3, a flow of operation of the information processing system according to the first example embodiment (especially, processing of adding the digital watermark) will be described. FIG. 3 is a flowchart illustrating the flow of the operation of the information processing system according to the first example embodiment.

As illustrated in FIG. 3, when the operation by the information processing system 10 according to the first example embodiment is started, first, the feature quantity acquisition unit 110 acquires the feature quantity of the ear canal of the target detected by the feature quantity detection unit 53 in the hearable device 50 (step S101). The feature quantity of the ear canal of the target acquired by the feature quantity acquisition unit 110 is outputted to the digital watermark generation unit 120. Thereafter, the digital watermark generation unit 120 generates the digital watermark from the feature quantity of the ear canal of the target acquired by the feature quantity acquisition unit 110 (step S102). The digital watermark generated by the digital watermark generation unit 120 is outputted to the digital watermarking unit 140.

Subsequently, the audio data acquisition unit 130 acquires the audio data including the speech of the target (step S103). The audio data acquired by the audio data acquisition unit 130 is outputted to the digital watermarking unit 140. The acquisition of the audio data may be performed simultaneously and in parallel with the step S101 and the step S102, or may be performed one after the other. The acquisition of the audio data may be started and ended in response to an operation of the target (e.g., an operation of a recording button). The acquisition of the audio data may also be performed in a case where the wearing of the hearable device 50 is detected. Alternatively, the acquisition of the audio data may be started in a case where the target speaks a particular word, or in accordance with a feature quantity of a voice of the target.

Subsequently, the digital watermarking unit 140 adds the digital watermark generated by the digital watermark generation unit 120 to the audio data acquired by the audio data acquisition unit 130 (step S104). The audio data to which the digital watermark is added, may be stored in a database or the like. A configuration in which the information processing system 10 includes a database will be described in more detail later.

### Example of Recording Processing

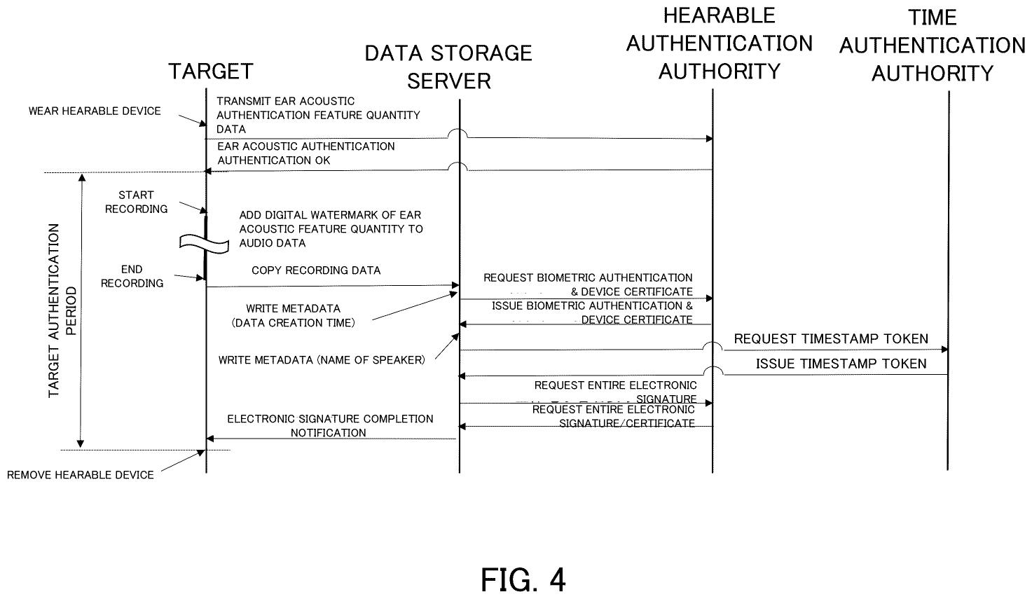

Referring now to FIG. 4, a flow of recording processing (i.e., processing when acquiring the audio data and adding the digital watermark thereto) in the information processing system 10 according to the first example embodiment will be described with a more specific example. FIG. 4 is a sequential diagram illustrating an example of the recording processing by the information processing system according to the first example embodiment.

As illustrated in FIG. 4, when the recording processing is performed by the information processing system 10 according to the first example embodiment, first, feature quantity data (i.e., data indicating the feature quantity of the ear canal) are transmitted from the hearable device 50 worn by the target to a hearable authentication authority. Then, the hearable authentication authority performs authentication about the received feature quantity data, and transmits, to the hearable device 50, information indicating that the ear acoustic authentication is successful.

Subsequently, recording of the audio data is started in the hearable device 50. When the recording of the audio data is ended, the recorded audio data are copied (stored) in a data storage server. Here, a data creation time is written in the audio data, as metadata. As described above, the digital watermark generated on the basis of the feature quantity used in the ear acoustic authentication is added to the recorded audio data. The digital watermark may be added in the hearable device or in the data storage server.

Subsequently, a request for a biometric authentication certificate and a device certificate is transmitted from the data storage server to the hearable authentication authority. In response to this requirement, the hearable authentication authority returns a biometric authentication certificate and a device certificate, to the data storage server. Here, a name of a speaker (i.e., the target) is written in the audio data, as metadata.

Then, necessary data area transmitted from the data storage server to a time authentication authority to request a timestamp token. In response to this requirement, the time authentication authority generates a timestamp token and returns it to the data storage server. Subsequently, an entire electronic signature is requested from the data storage server to the hearable authentication authority. In response to this requirement, the hearable authentication authority returns an entire electronic signature to the data storage server.

The data storage server then transmits an electronic signature completion notification to the target. Then, when the target removes the hearable device 50, a target authentication period (i.e., a period when the target is authenticated to wear the hearable device 50) is ended. In a case where the target is not wearing the hearable device at the end of the recording of the audio data, an error may be reported in order not to generate the audio data with authentication.

### Example of Reproduction Processing

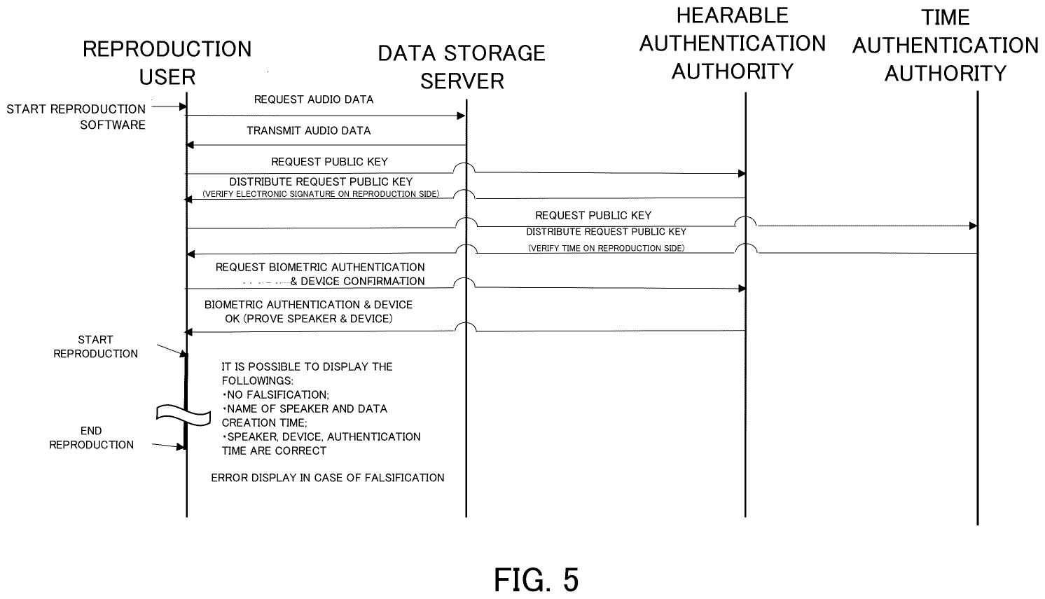

Referring now to FIG. 5, a flow of reproduction processing (i.e., processing when reproducing the audio data to which the digital watermark is added) in the information processing system 10 according to the first example embodiment will be described with a more specific example. FIG. 5 is a sequence diagram illustrating an example of the reproduction processing by the information processing system according to the first example embodiment.

As illustrated in FIG. 5, when the reproduction processing is performed by the information processing system 10 according to the first example embodiment, first, a request for the audio data is transmitted to the data storage server when reproduction software is started by the user. In response to this request, the data storage server transmits the audio data to the user (reproduction software).

Then, the user acquires a public key of the hearable authentication authority to decode the electronic signature, and verifies that there is no falsification. The user then acquires a public key of the time authentication authority to decode the timestamp token, confirms that there is no falsification, and obtains time information certified by the time authentication authority.

Then, a request for biometric authentication and device confirmation is transmitted from the user to the hearable authentication authority. In response to this request, the hearable authentication authority transmits, to the user, an indication of biometric authentication and device OK (i.e., an indication that the speaker and the device are authenticated).

After that, the reproduction of the audio data is started in the reproduction software. When the audio data are reproduced, it is possible to display an indication that there is no falsification in the audio data, that the name of the speaker and the data creation time, and an indication that the speaker, the device, and the authentication time are correct, on the basis of results of each processing described above. When the audio data are reproduced, the user may freely perform operations such as fast-forwarding and rewinding.

### Data Structure

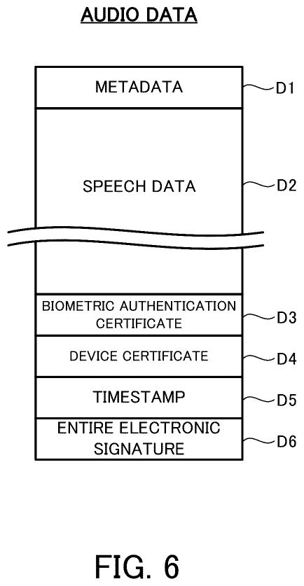

Next, with reference to FIG. 6, a data structure of the audio data (specifically, the audio data to which the digital watermark is added) handled in the information processing system 10 according to the first example embodiment will be described. FIG. 6 is a conceptual diagram illustrating an example of the data structure of the audio data handled by the information processing system according to the first example embodiment.

As illustrated in FIG. 6, the audio data to which the digital watermark is added, includes metadata D1, speech data D2, a biometric authentication certificate D3, a device certificate D4, a timestamp D5, and an entire electronic signature D6.

The metadata D1 are information including personal information including the name of the authenticated speaker or the like, and time information about data creation.

The speech data D2 are data including speech content of the speaker (e.g., waveform data). The digital watermark is added to the speech data D2 as described above.

The biometric authentication certificate D3 is information indicating that the authentication is successful, by using the biometric information about the speaker (e.g., the feature quantity of the ear canal).

The device certificate D4 is informational about the hearable device 50. The device certificate D4 may be information proving that the hearable device 50 that acquires the audio data is an authenticated device.

The timestamp D5 is information created on the basis of the metadata D1, the speech data D2, the biometric authentication certificate D3, and the device certificate D4 (e.g., information indicating that there is no falsification or the like at that time). The timestamp D5 may be created from hash values of the metadata D1, the biometric authentication certificate D3, and the device certificate D4, for example.

The entire electronic signature D6 is an electronic signature created on the basis of the metadata D1, the speech data D2, the biometric authentication certificate D3, the device certificate D4, and the timestamp D5.

The data structure of the audio data described above is only an example, and the information processing system 10 according to the present example embodiment is also allowed to handle the audio data having a data structure that is different from the above.

### Technical Effect

Next, a technical effect obtained by the information processing system 10 according to the first example embodiment will be described.

As described in FIG. 1 to FIG. 6, in the information processing system 10 according to the first example embodiment, the digital watermark is generated from the biometric feature quantity of the target, and the generated watermark is added to the audio data including the speech of the target. In this way, it is possible to ensure integrity, authenticity, and non-repudiation of the audio data. Therefore, it is possible to prevent fraud/misconduct using the audio data, such as, for example, transmitting speech with different content from an intention of a person himself/herself. In addition, by ensuring the integrity of the entire audio data, the intention of speech of the person himself/herself can be faithfully reproduced to a listener. For example, in recent news reports or the like, it is seen here and there that only a part of speech is taken out and that a different impression from the intention of the person himself/herself is added to the listener. This problem can be solved by reproducing the audio data in this system. Furthermore, in the present invention, the integrity is ensured even for nuances due to an empty time in the speech when the person himself/herself is not making a sound. In speech authentication or the like, the authentication is not possible unless the person himself/herself speaks; however, in this system, personal authentication is possible even when the person himself/herself is not speaking. In addition, in a case where the audio data include speech content other than that of the target (e.g., in a case where the hearable device 50 also picks up the speech content of another person), it is possible to prove a fact that the target hears it.

In the above example embodiment, the hearable device 50 that acquires the feature quantity of the ear canal of the target is exemplified, but a device that acquires the feature quantity of the target is not limited to the hearable device 50. For example, instead of the hearable device 50, a device that is configured to acquire at least one of a face, an iris, a voice, and a fingerprint of the target, may be used to acquire the feature quantity of the target. For example, a camera device may acquire the face or iris of the target. A device with a fingerprint sensor may be used to acquire the fingerprint of the target. A device with a microphone may be used to acquire the voice of the target.

### Second Example Embodiment

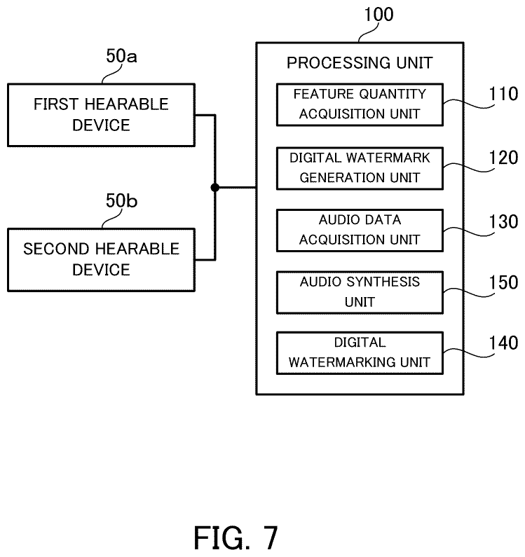

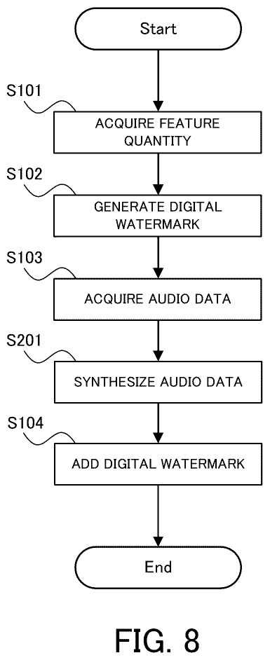

The information processing system 10 according to a second example embodiment will be described with reference to FIG. 7 and FIG. 8. The second example embodiment is partially different from the first example embodiment only in the configuration and operation, and may be the same as the first example embodiment in the other parts. For this reason, a part that is different from the first example embodiment will be described in detail below, and a description of the other overlapping parts will be omitted as appropriate.

### Functional Configuration

First, a functional configuration of the information processing system 10 according to the second example embodiment will be described with reference to FIG. 7. FIG. 7 is a block diagram illustrating the functional configuration of the information processing system according to the second example embodiment. In FIG. 8, the same components as those illustrated in FIG. 2 carry the same reference numerals.

As illustrated in FIG. 7, the information processing system 10 according to the second example embodiment includes a first hearable device 50a, a second hearable device 50b, and the processing unit 100. The first hearable device 50a is a device to be worn by a first target, and the second hearable device 50b is a device to be worn by a second target (i.e., a target who is different from the first target). The first hearable device 50a and the second hearable device 50b are respectively configured to communicate with the processing unit 100. The first hearable device 50a and the second hearable device 50b may have the same configuration as that of the hearable device 50 (see FIG. 2) in the first example embodiment.

The processing unit 100 according to the second example embodiment includes, as components for implementing the functions thereof, the feature quantity acquisition unit 110, the watermark generation unit 120, the audio data acquisition unit 130, the digital watermarking unit 140, and an audio synthesis unit 150. That is, the processing unit 100 according to the second example embodiment further includes the audio synthesis unit 150, in addition to the configuration in the first example embodiment (see FIG. 2). The audio synthesis unit 150 may be a functional block realized or implemented by the processor 11 (see FIG. 1), for example.

The audio synthesis unit 150 is configured to synthesize first audio data acquired from the first hearable device 50a and second audio data acquired from the second hearable device 50b, thereby to generate synthesized audio data. A method of synthesizing the voice/sound/audio is not particularly limited, but for example, processing in which a part where a sound volume is low or it is noisy, is overwritten by another piece of the audio data, may be performed. For example, in the first audio data acquired by the first hearable device 50a, speech of the first target has a relatively high volume, while speech of the second target has a relatively low volume. On the other hand, in the second audio data acquired by the second hearable meanwhile 50b, the speech of the first target has a relatively low volume, while the speech of the second target has a relatively high volume. Therefore, if a speech part of the second target in the first audio data is overwritten by a corresponding part of the second audio data, it is possible to optimize a volume difference between speakers.

### Flow of Operation

Next, a flow of operation of the information processing system 10 according to the second example embodiment will be described with reference to FIG. 8. FIG. 8 is a flowchart illustrating the flow of the operation by the information processing system according to the second example embodiment. In FIG. 8, the same steps as those illustrated in FIG. 3 carry the same reference numerals.

As illustrated in FIG. 8, when the operation by the information processing system 10 according to the second example embodiment is started, first, the feature quantity acquisition unit 110 acquires the feature quantity of the ear canal of the target detected by the feature quantity detection unit 53 in the hearable device 50 (step S101). In the second example embodiment, the feature quantity of the ear canal of the first target may be acquired in the first hearable device 50a, and the feature quantity of the ear canal of the second target may be acquired in the second hearable device 50b.

Thereafter, the digital watermark generation unit 120 generates the digital watermark from the feature quantity of the ear canal of the target acquired by the feature quantity acquisition unit 110 (step S102). Especially in the second example embodiment, the digital watermark corresponding to the first target may be generated from the feature quantity of the ear canal of the first target, and the digital watermark corresponding to the second target may be generated from the feature quantity of the ear canal of the second target.

Subsequently, the audio data acquisition unit 130 acquires the audio data including the speech of the target (step S103). In the second example embodiment, the first audio data are acquired from the first hearable device 50a and the second audio data are acquired from the second hearable device 50b. Then, the audio synthesis unit 150 synthesizes the first audio data and the second audio data, thereby to generate the synthesized audio data (step S201).

Subsequently, the digital watermarking unit 140 adds the digital watermark generated by the digital watermark generation unit 120 to the synthesized audio data synthesized by the audio synthesis unit 150 (step S104). The digital watermarking unit 140 may add both the digital watermark corresponding to the first target and the digital watermark corresponding to the second target, or may add only one of them.

### Technical Effect

Next, a technical effect obtained by the information processing system 10 according to the second example embodiment will be described.

As described in FIG. 7 and FIG. 8, in the information processing system 10 according to the second example embodiment, the first audio data and the second audio data acquired from the separate devices are synthesized, and the digital watermark is added to the synthesized audio data. In this way, it is possible to add the digital watermark while reducing/suppressing the volume difference and noise caused by a difference in a recording environment (i.e., a recording terminal).

### Third Example Embodiment

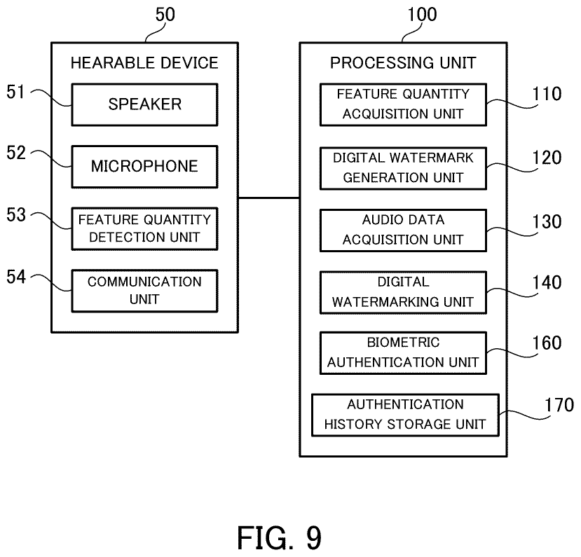

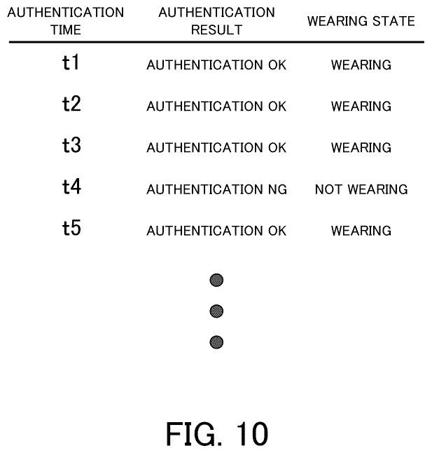

The information processing system 10 according to a third example embodiment will be described with reference to FIG. 9 and FIG. 10. The third example embodiment is partially different from the first and second example embodiments only in the configuration and operation, and may be the same as the first and second example embodiments in the other parts. For this reason, a part that is different from each of the example embodiments described above will be described in detail below, and a description of the other overlapping parts will be omitted as appropriate.

### Functional Configuration

First, a functional configuration of the information processing system 10 according to the third example embodiment will be described with reference to FIG. 9. FIG. 9 is a block diagram illustrating the functional configuration of the information processing system according to the third example embodiment. In FIG. 9, the same components as those illustrated in FIG. 2 carry the same reference numerals.

As illustrated in FIG. 9, the information processing system 10 according to the third example embodiment includes the hearable device 50 and the processing unit 100. Especially, the processing unit 100 according to the third example embodiment includes, as components for realizing the functions thereof, the feature quantity acquisition unit 110, the digital watermark generation unit 120, the audio data acquisition unit 130, the digital watermarking unit 140, a biometric authentication unit 160, and an authentication history storage unit 170. That is, the processing unit 100 according to the third example embodiment further includes the biometric authentication unit 160 and the authentication history storage unit 170, in addition to the configuration in the first example embodiment (see FIG. 2). The biometric authentication unit 160 may be a functional block realized or implemented by the processor 11 (see FIG. 1), for example. The authentication history storage unit 170 may be realized or implemented by the storage apparatus 14 or the like, for example.

The biometric authentication unit 160 is configured to perform biometric authentication about the target. Especially, the biometric authentication unit 160 is configured to perform the biometric authentication at a plurality of times during the recording of the audio data. For example, the biometric authentication unit 160 may perform the biometric authentication with a predetermined period (e.g., at intervals of a few seconds or a few minutes). The biometric authentication performed by the biometric authentication unit 160 may be ear acoustic authentication. In this instance, the biometric authentication unit 160 may perform the biometric authentication, by using the feature quantity of the ear canal acquired by the feature quantity acquisition unit 110. The biometric authentication performed by the biometric authentication unit 160, however, may be other than the ear acoustic authentication. For example, the biometric authentication unit 160 may be configured to perform fingerprint authentication, face recognition, and iris recognition. In this instance, the biometric authentication unit 160 may acquire the feature quantity used for the biometric authentication, by using various scanners, cameras, and the like.

The authentication history storage unit 170 is configured to store a result history of the biometric authentication by the biometric authentication unit 160. Specifically, the authentication history storage unit 170 stores whether or not the authentication is successful, in each of a plurality of times of biometric authentication performed by the biometric authentication unit 160. The history stored in the authentication history storage unit 170 may be confirmed on the reproducing software, when the audio data are reproduced, for example.

Although described here is an example in which the processing unit 100 includes the biometric authentication unit 160 and the authentication history storage unit 170, at least one of the biometric authentication unit 160 and the authentication history storage unit 170 may be provided in the hearable device 50.

### Biometric Authentication Operation

Next, with reference to FIG. 10, the operation and the stored result history related to the biometric authentication by the information processing system 10 according to the third example embodiment will be described. FIG. 10 is a conceptual diagram illustrating an example of authentication processing by the information processing system according to the third example embodiment.

As illustrated in FIG. 10, in the information processing system 10 according to the third example embodiment, the biometric authentication unit 160 performs the biometric authentication at times t1, t2, t3, t4, t5, and so on. The authentication history storage unit 170 stores results of the biometric authentication at the respective times. In the example illustrated in the figure, the following history is stored: the biometric authentication is successful (OK) at the time t1, t the biometric authentication is successful (OK) at the time t2, the biometric authentication is successful (OK) at the time t3, the biometric authentication is failed (NG) at the time t4, and the biometric authentication is successful (OK) at the time t5. The authentication history storage unit 170 also stores whether or not the target is wearing the hearable device 50. In the example illustrated in the figure, the following history is stored: wearing at the time t1, wearing at the time t2, wearing at the time t3, not wearing at the time t4, and wearing at the time t5. From the history as described above, it can be seen that the biometric authentication is failed because the target removes the hearable device 50 at the time t4, for example.

### Technical Effect

Next, a technical effect obtained by the information processing system 10 according to the third example embodiment will be described.

As described in FIG. 9 and FIG. 10, in the information processing system 10 according to the third example embodiment, the biometric authentication is performed at a plurality of times during the recording, and the results are stored as the history. In this way, even if the target person himself/herself is not authenticated on the basis of whether or not the hearable device 50 is worn (e.g., as illustrated in FIG. 4, a period until the hearable device 50 is removed is not set as the target authentication period), it is possible to prove, from the history, a fact that the target person himself/herself speaks, for the audio data. In addition, by performing the biometric authentication at a plurality of times, it is possible to identify a period when the target is not authenticated. Therefore, it is possible to easily discover fraud/misconduct such as falsification, for example. Even in a case where the target authentication period is a period when the hearable device 50 is worn, the authentication is continuously performed during the period, and that makes it possible to prevent that the hearable device 50 is disassembled to change the authentication period in an unauthorized manner.

### Fourth Example Embodiment

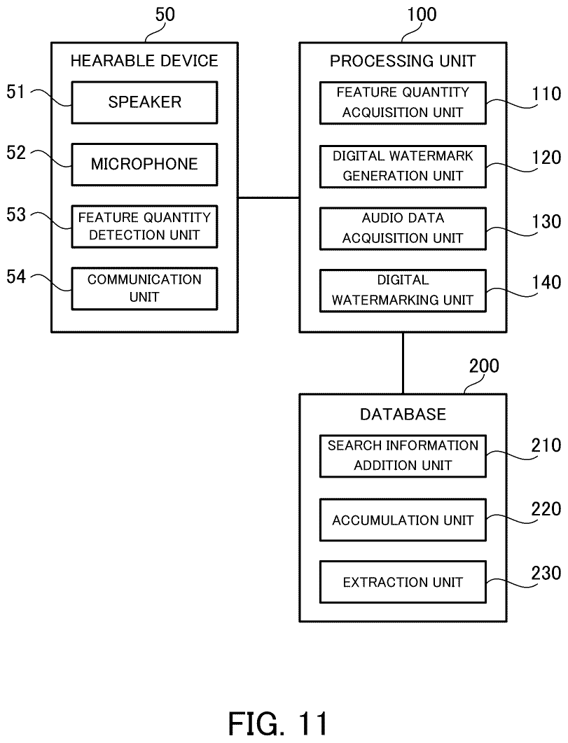

The information processing system 10 according to a fourth example embodiment will be described with reference to FIG. 11 to FIG. 13. The fourth example embodiment is partially different from the first to third example embodiments only in the configuration and operation, and may be the same as the first to third example embodiments in the other parts. For this reason, a part that is different from each of the example embodiments described above will be described in detail below, and a description of the other overlapping parts will be omitted as appropriate.

### Functional Configuration

First, a functional configuration of the information processing system 10 according to the fourth example embodiment will be described with reference to FIG. 11. FIG. 11 is a block diagram illustrating the functional configuration of the information processing system according to the fourth example embodiment. In FIG. 11, the same components as those illustrated in FIG. 2 carry the same reference numerals.

As illustrated in FIG. 11, the information processing system 10 according to the fourth example embodiment includes the hearable device 50, the processing unit 100, and a database 200. That is, the information processing system 10 according to the fourth example embodiment further includes the database 200, in addition to the configuration in the first example embodiment (see FIG. 2).

The database 200 is configured to accumulate the audio data to which the digital watermark is added in the processing unit 100. The database 200 may be realized or implemented, by the storage apparatus 14 (see FIG. 1), for example. The database 200 includes, as components for realizing the functions thereof, a search information addition unit 210, an accumulation unit 220, and an extraction unit 230.

The search information addition unit 210 is configured to add search information (information used to search for the audio data) to the audio data to which the digital watermark is added. Specifically, the search information addition unit 210 adds, to the audio data, at least one of a keyword included in the speech content, information about the target, and date and time of the speech, as the search information (i.e., associates the at least one with the audio data). The keyword included in the speech content may be acquired by converting the audio data into text, for example. The information about the target may be personal information such as the name of the target, or the feature quantity of the target (e.g., the feature quantity used for the biometric authentication or the feature quantity of a voice). The date and time of the speech may be acquired from the timestamp (see FIG. 6) included in the audio data, for example.

The accumulation unit 220 is configured to accumulate the audio data to which the search information is added by the search information addition unit 210. The accumulation unit 220 is configured to store a plurality of pieces of audio data to which the search information is added, and to output the audio data in response to a request, as appropriate.

The extraction unit 230 is configured to extract data matching an inputted search query, from the audio data stored in the accumulation unit 220. The information added as the search information by the search information addition unit 210 may be inputted as the search query to the extraction unit 230. That is, the search query including the keyword included in the speech content, the information about the target, and the date and time of the speech, may be inputted to the search information addition unit 210. The extraction unit 230 may extract only one piece of audio data whose matching degree with the search query is the highest. The extraction unit 230 may extract a plurality of pieces of audio data whose matching degree with the search query is higher than a predetermined value.

### Flow of Operation

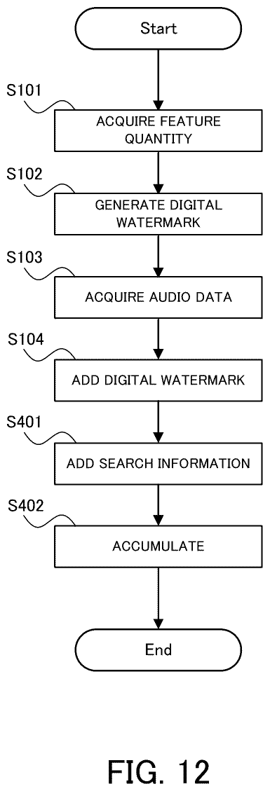

Next, with reference to FIG. 12, a flow of operation of the information processing system 10 according to the fourth example embodiment (especially, operation until the audio data are accumulated) will be described. FIG. 12 is a flowchart illustrating the flow of the operation performed by the information processing system according to the fourth example embodiment. In FIG. 12, the same steps as those illustrated in FIG. 3 carry the same reference numerals.

As illustrated in FIG. 12, when the operation by the information processing system 10 according to the fourth example embodiment is started, first, the feature quantity acquisition unit 110 acquires the feature quantity of the ear canal of the target detected by the feature quantity detection unit 53 in the hearable device 50 (step S101). Thereafter, the digital watermark generation unit 120 generates the digital watermark from the feature quantity of the ear canal of the target acquired by the feature quantity acquisition unit 110 (step S102).

Subsequently, the audio data acquisition unit 130 acquires the audio data including the speech of the target (step S103). Then, the digital watermarking unit 140 adds the digital watermark generated by the digital watermark generation unit 120 to the audio data acquired by the audio data acquisition unit 130 (step S104).

Subsequently, the search information addition unit 210 adds the search information to the audio data to which the digital watermark is added (step S401). Then, the accumulation unit 220 accumulates the audio data to which the search information is added by the search information addition unit 210 (step S402). The search information addition unit 210 may add the search information after the audio data are accumulated in the accumulation unit 220. That is, the step S401 may be performed after the step S402.

### Search Operation

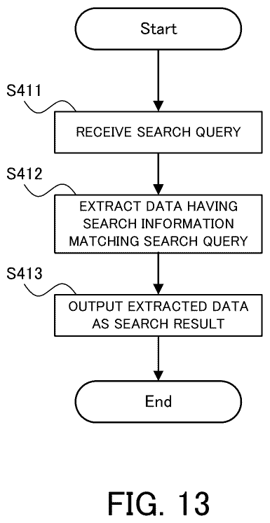

Next, with reference to FIG. 13, an operation when the audio data are searched in the information processing system 10 according to the fourth example embodiment will be described. FIG. 13 is a flowchart illustrating a flow of a search operation by the information processing system according to the fourth example embodiment.

As illustrated in FIG. 13, in the search operation by the information processing system 10 according to the fourth example embodiment, first, the extraction unit 230 receives the search query (step S411). The search query may be inputted as a word corresponding to the search information. Alternatively, features of a voice or speech/sound/audio (waveform data) recorded by a terminal such as a smartphone may be used as the search query.

Subsequently, the extraction unit 230 extracts data matching the inputted search query, from the plurality of pieces of audio data accumulated in the accumulation unit 220 (step S412). Then, the extraction unit 230 outputs the extracted audio data as a search result (step S413). In a case where even a piece of audio data matching the search query is not found, the extraction unit 230 may output the fact as the search result.

### Technical Effect

Next, a technical effect obtained by the information processing system 10 according to the fourth example embodiment will be described.

As described in FIG. 11 to FIG. 13, in the information processing system 10 according to the fourth example embodiment, the audio data to which the search information is added, are stored. In this way, it is possible to properly extract desired audio data from the plurality of piece of audio data accumulated. Furthermore, since the search information according to the present example embodiment includes at least one of the keyword included in the speech content, the information about the target, and the date and time of the speech, it is possible to properly perform the extraction even in a case where information about the audio data to be desirably extracted is more or less ambiguous.

### Fifth Example Embodiment

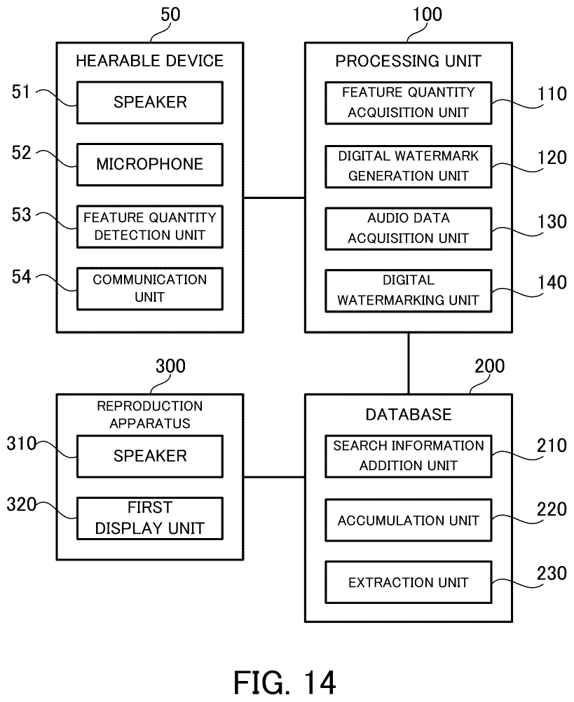

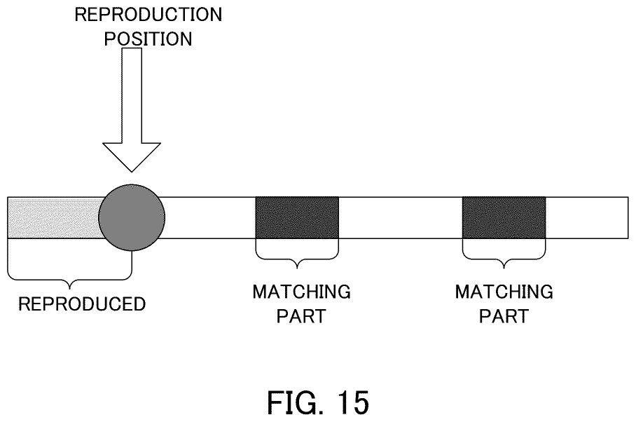

The information processing system 10 according to a fifth example embodiment will be described with reference to FIG. 14 and FIG. 15. The fifth example embodiment is partially different from the fourth example embodiment only in the configuration and operation, and may be the same as those of the first to fourth example embodiments in the other parts. For this reason, a part that is different from each of the example embodiments described above will be described in detail below, and a description of the other overlapping parts will be omitted as appropriate.

### Functional Configuration

First, a functional configuration of the information processing system 10 according to the fifth example embodiment will be described with reference to FIG. 14. FIG. 14 is a block diagram illustrating the functional configuration of the information processing system according to the fifth example embodiment. In FIG. 14, the same components as those illustrated in FIG. 11 carry the same reference numerals.

As illustrated in FIG. 14, the information processing system 10 according to the fifth example embodiment includes the hearable device 50, the processing unit 100, the database 200, and a reproduction apparatus 300. That is, the information processing system 10 according to the fifth example embodiment further includes the reproduction apparatus 300, in addition to the configuration in the fourth example embodiment (see FIG. 11).

The reproduction apparatus 300 is configured as an apparatus capable of reproducing the audio data accumulated in the database 200. The reproduction apparatus 300 may be realized or implemented by the output apparatus 16 (see FIG. 1), for example. The reproduction apparatus 300 includes, as components for realizing the functions thereof, a speaker 310 and a first display unit 320.

The speaker 310 is configured to reproduce the audio data acquired from the database 200. The speaker 310 here may be the speaker 51 provided in the hearable device 50. That is, the hearable device 50 may have a function as the reproduction apparatus 300.

The first display unit 320 is configured to display a seek bar when the audio data are reproduced. Especially, the seek bar displayed by the first display unit 320 is displayed in a display aspect in which a part matching the search query can be visually recognized. The first display unit 320 may acquire information about the part matching the search query, by using an extraction result of the extraction unit 230. A specific display example of displaying the seek bar will be described in detail below.

### Display Example of Seek Bar

Next, with reference to FIG. 15, a display example of displaying the seek bar by the information processing system 10 according to the fifth example embodiment will be described. FIG. 15 is a diagram illustrating an example of the seek bar displayed in the information processing system according to the fifth example embodiment.

As illustrated in FIG. 15, in the information processing system 10 according to the fifth example embodiment, the seek bar is displayed on a display or the like provided in a device for reproducing the audio data, for example. The seek bar represents the entire audio data, and a round part is a current reproduction part. The round part gradually moves to the right as a reproduction time passes. Therefore, a left part from the round part is a reproduced part, and a right part from the round part is an unreproduced part.

Especially in the present example embodiment, the part matching the search query is displayed to be recognizable on the seek bar. For example, as illustrated in the figure, the part matching the search query may be displayed in a different color from the other part. The part matching the search query, however, may be displayed in a display aspect other than the exemplified aspect here. The part matching the search query may be, for example, a part including a word included in the search query, or a part spoken by the speaker included in the search query. Alternatively, in a case where the search is performed by using the recorded voice/sound/audio, a part corresponding to the recorded voice/sound/audio (waveform) may be determined to be the part matching the search query.

### Technical Effect

Next, a technical effect obtained by the information processing system 10 according to the fifth example embodiment will be described.

As described in FIG. 14 and FIG. 15, in the information processing system 10 according to the fifth example embodiment, the seek bar is displayed in the display aspect in which the part matching the search query can be recognized. In this way, it is possible to make the user visually recognize, from the audio data, a part that the user who performs the search would like to know.

### Sixth Example Embodiment

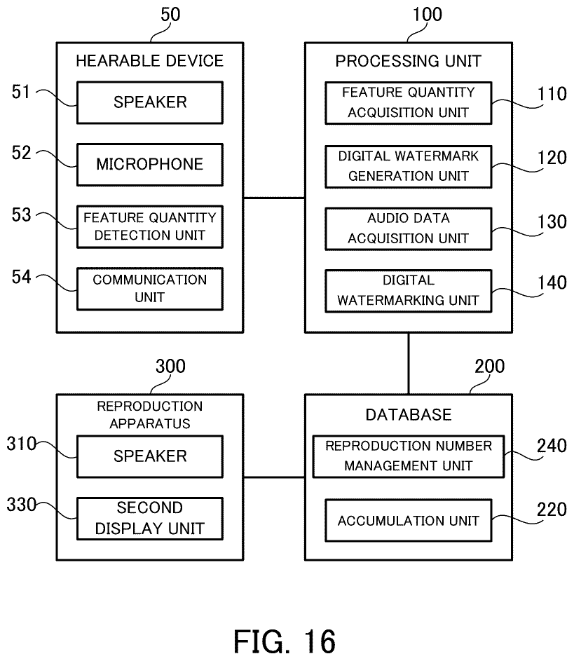

The information processing system 10 according to a sixth example embodiment will be described with reference to FIG. 16 to FIG. 18. The sixth example embodiment is partially different from the fifth example embodiment only in the configuration and operation, and may be the same as the first to fifth example embodiments in the other parts. For this reason, a part that is different from each of the example embodiments described above will be described in detail below, and a description of the other overlapping parts will be omitted as appropriate.

### Functional Configuration

First, with reference to FIG. 16, a functional configuration of the information processing system 10 according to the sixth example embodiment will be described. FIG. 16 is a block diagram illustrating the functional configuration of the information processing system according to the sixth example embodiment. In FIG. 16, the same components as those illustrated in FIG. 14 carry the same reference numerals.

As illustrated in FIG. 16, the information processing system 10 according to the sixth example embodiment includes the hearable device 50, the processing unit 100, the database 200, and the reproduction apparatus 300.

The database 200 according to the sixth example embodiment includes, as components for realizing the functions thereof, the accumulation unit 220 and a reproduction number management unit 240. That is, the database 200 according to the sixth example embodiment includes the reproduction number management unit 240, instead of the search information addition unit 210 and the extraction unit 230 in the database 200 according to the fifth example embodiment (see FIG. 14). The database 200 according to the sixth example embodiment may include the search information assigning unit 210 and the extraction unit 230, in addition to the reproduction number management unit 240 (i.e., may have the same search function as in the fifth example embodiment).

The reproduction number management unit 240 manages the number of times of reproduction of the plurality of pieces of audio data accumulated in the accumulation unit 220. Specifically, the reproduction number management unit 240 stores the number of times of reproduction of each piece of audio data, for each part of the audio data. For example, the reproduction number management unit 240 divides the audio data into a plurality of parts at predetermined time intervals, and stores the number of times of reproduction for each divided part.

The reproducing apparatus 300 according to the sixth example embodiment includes the speaker 310 and a second display unit 330. That is, the reproduction apparatus 300 according to the sixth form includes the second display portion 330, instead of the first display portion 320 in the reproduction apparatus 300 according to the fifth example embodiment (see FIG. 14). The second display unit 330, however, may have a function as the first display unit 320 (i.e., a function of displaying the part matching the search query).

The second display unit 330 is configured to display the seek bar when the audio data are reproduced. Especially, the seek bar displayed by the second display unit 330 is displayed in a display aspect in which a part reproduced many times can be visually recognized. The second display unit 330 may acquire information about the part reproduced many times, from the reproduction number management unit 240. A specific display example of displaying the seek bar will be described in detail below.

### Display Example of Seek Bar

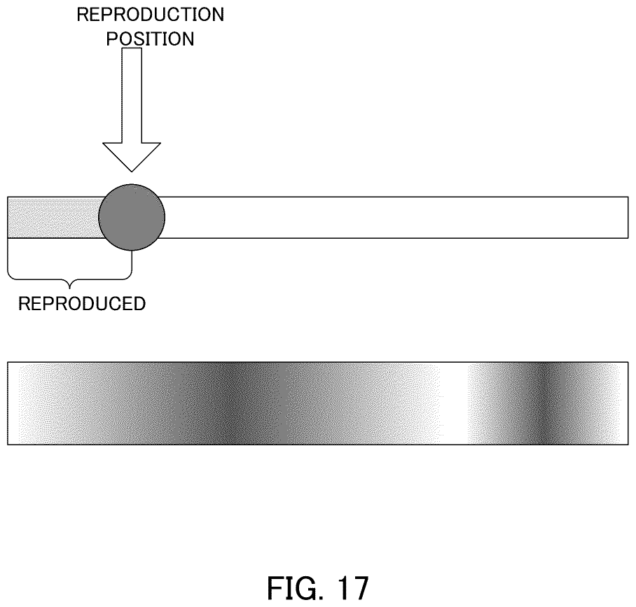

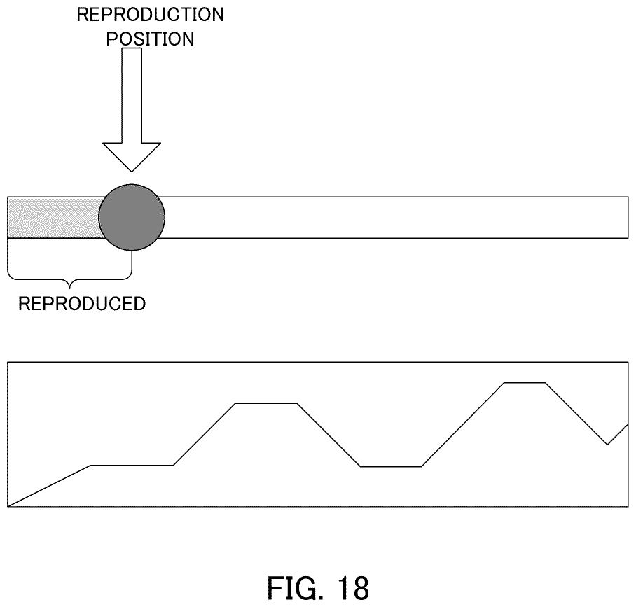

Next, with reference to FIG. 17 and FIG. 18, a display example of displaying the seek bar by the information processing system 10 according to the sixth example embodiment will be described. FIG. 17 is version 1 of a diagram illustrating an example of the seek bar displayed in the information processing system according to the sixth example embodiment. FIG. 18 is version 2 of a diagram illustrating an example of the seek bar displayed in the information processing system according to the sixth example embodiment.

As illustrated in FIG. 17, in the information processing system 10 according to the sixth example embodiment, for example, the seek bar is displayed on a display or the like provided in a device for reproducing the audio data. Especially in the present example embodiment, a heat map indicating the number of times of reproduction may be displayed under the seek bar. In this heat map, a dark color part indicates a large number of times of reproduction, and a light color part indicates a small number of times of reproduction. The heat map is generated on the basis of information about the number of times of reproduction acquired from the reproduction number management unit 240. Alternatively, the reproduction number management unit 240 may store the number of times of reproduction in a heat map form.

As illustrated in FIG. 18, a graph indicating the number of times of reproduction may be displayed under the seek bar. This graph indicates that the number of times of reproduction increases in an upper part and decreases in a lower part. The graph is generated on the basis of the information about the number of times of reproduction acquired from the reproduction number management unit 240. Alternatively, the reproduction number management unit 240 may store the number of times of reproduction in a graph form.

### Technical Effect

Next, a technical effect obtained by the information processing system 10 according to the sixth example embodiment will be described.

As described in FIG. 16 to FIG. 18, in the information processing system 10 according to the sixth example embodiment, the seek bar is displayed in the display aspect in which the part reproduced many times can be recognized. In this way, it is possible to make the user visually recognize, from the audio data, a part in which other users are also interested (in other words, a popular part).

The fifth and sixth example embodiments may be realized or implemented in combination. That is, the part matching the search query may be displayed in the seek bar, together with the information indicating the number of times of reproduction.

### Seventh Example Embodiment

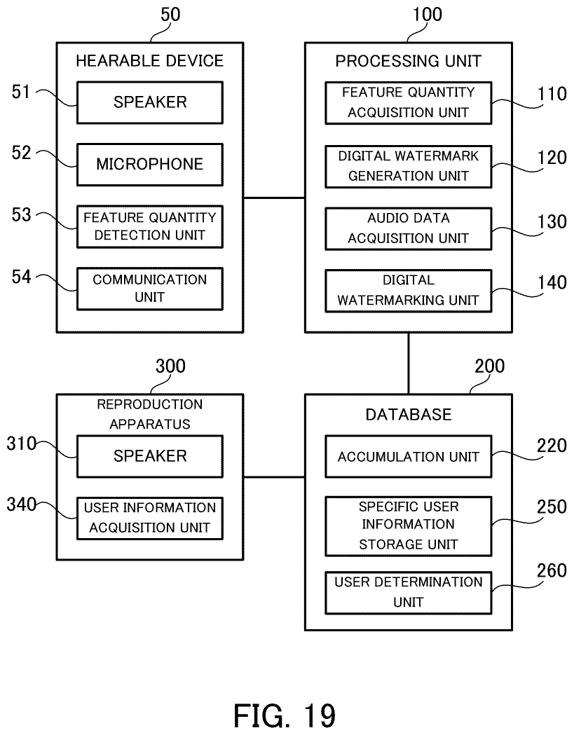

The information processing system 10 according to a seventh example embodiment will be described with reference to FIG. 19 to FIG. 21. The seventh example embodiment is partially different from the first to sixth example embodiments only in the configuration and operation, and may be the same as the first to sixth example embodiments in the other parts. For this reason, a part that is different from each of the example embodiments described above will be described in detail below, and a description of the other overlapping parts will be omitted as appropriate.

### Functional Configuration

First, with reference to FIG. 19, a functional configuration of the information processing system 10 according to the seventh example embodiment will be described. FIG. 19 is a block diagram illustrating the functional configuration of the information processing system according to the seventh example embodiment. In FIG. 19, the same components as those illustrated in FIG. 14 carry the same reference numerals.

As illustrated in FIG. 19, the information processing system 10 according to the seventh example embodiment includes the hearable device 50, the processing unit 100, the database 200, and the reproduction apparatus 300.

The database 200 according to the seventh example embodiment includes, as components for realizing the functions thereof, the accumulation unit 220, a specific user information storage unit 250, and a user determination unit 260. That is, the database 200 according to the seventh example embodiment includes the specific user information storage unit 250 and the user determination unit 260, instead of the search information addition unit 210 and the extraction unit 230 in the database 200 according to the fifth example embodiment (see FIG. 14). The database 200 according to the sixth example embodiment may include the search information assigning unit 210 and the extraction unit 230, in addition to the specific user information storage unit 250 and the user determination unit 260 (i.e., may have the same search function as in the fifth example embodiment).

The specific user information storage unit 250 is configured to store information about a specific user. The “specific user” here is a user who is different from the target and is permitted to reproduce the audio data to which the digital watermark is added. The information about the specific user is not particularly limited as long as the information allows the specific user to be identified, but may be, for example, personal information such as the name of the specific user, or biometric information (e.g., a feature quantity) about the specific user, or the like. Alternatively, it may be an ID and a password optionally set by the specific user or automatically set by the system. The audio data according to the present example embodiment may be based on the assumption that a user other than the target reproduces the audio data, as is seen from a fact that the specific user is set. An example of the audio data includes, for example, data including a will. In this case, the specific user may be, for example, a heir or a representative/agent, or the like.

The user determination unit 260 is configured to determine whether or not the audio data are reproduced by the specific user. The user determination unit 260 is configured to determine whether or not the audio data are reproduced by the specific user, by comparing user information acquired by a user information acquisition unit 340 described later (i.e., information about a user who reproduces the audio data) with specific user information stored in the specific user information storage unit 250. The user determination unit 260 may determine that the audio data are reproduced by the specific user, in a case where the user information acquired by the user information acquisition unit 340 matches the specific user information, for example. Furthermore, the user determination unit 260 may determine that the audio data are reproduced by a user other than the specific user, in a case where the user information acquired by the user information acquisition unit 340 does not match the specific user information.

The reproduction apparatus 300 according to the seventh example embodiment includes the speaker 310 and the user information acquisition unit 340. That is, the reproduction apparatus 300 according to the seventh example embodiment includes the user information acquisition unit 340, instead of the first display unit 320 in the reproduction apparatus 300 according to the fifth example embodiment (see FIG. 14). The reproduction apparatus 300 according to the seventh example embodiment may include the first display unit 320 (see FIG. 14) and the second display unit (see FIG. 16) in the user information acquisition unit 340. That is, it may have the function of displaying the seek bar described in the fifth and sixth example embodiments.

The user information acquisition unit 340 is configured to acquire information about the user who reproduces the audio data (hereinafter referred to as “reproduction user information”). The reproduction user information is acquired as information that is comparable with the specific user stored in the specific user information storage unit 250. The reproduction user information may be acquired by an input by the user himself/herself, or may be automatically acquired by using a camera or the like, for example.

### Flow of Operation

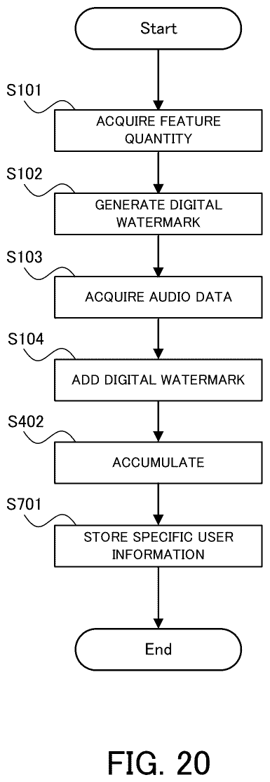

Next, with reference to FIG. 20, a flow of operation of the information processing system 10 according to the seventh example embodiment (especially, operation until the audio data are accumulated) will be described. FIG. 20 is a flowchart illustrating the flow of the operation by the information processing system according to the seventh example embodiment. In FIG. 20, the same steps as those illustrated in FIG. 12 carry the same reference numerals.

As illustrated in FIG. 20, when the operation by the information processing system 10 according to the seventh example embodiment is started, first, the feature quantity acquisition unit 110 acquires the feature quantity of the ear canal of the target detected by the feature quantity detection unit 53 in the hearable device 50 (step S101). Thereafter, the digital watermark generation unit 120 generates the digital watermark from the feature quantity of the ear canal of the target acquired by the feature quantity acquisition unit 110 (step S102).

Subsequently, the audio data acquisition unit 130 acquires the audio data including the speech of the target (step S103). Then, the digital watermarking unit 140 adds the digital watermark generated by the digital watermark generation unit 120 to the audio data acquired by the audio data acquisition unit 130 (step S104).

Then, the accumulation unit 220 accumulates the audio data to which the digital watermark is added (step S402). Thereafter, the specific user information storage unit 250 stores the information about the specific user who is permitted to reproduce the accumulated audio data (step S701). The specific user information may not be added to all the audio data. That is, there may be audio data that are not a determination target of whether or not the audio data are reproduced by the specific user.

### User Determination Operation

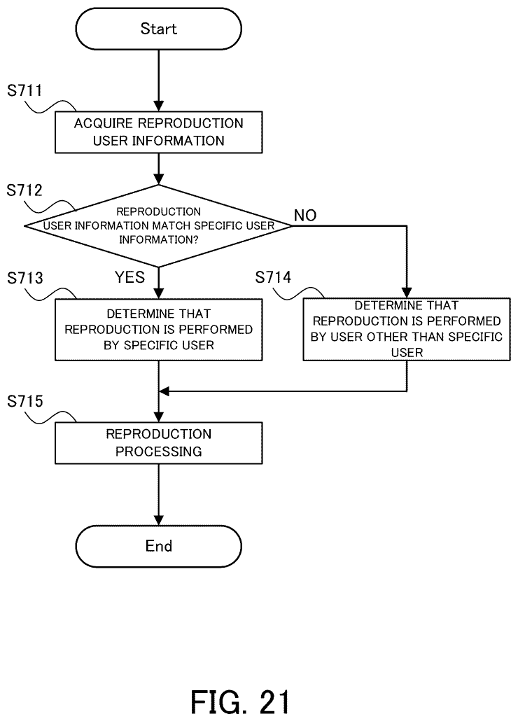

Next, with reference to FIG. 21, an operation when the audio data are reproduced in the information processing system 10 according to the seventh example embodiment will be described. FIG. 21 is a flowchart illustrating a flow of a reproduction operation by the information processing system according to the seventh example embodiment.

As illustrated in FIG. 21, when the audio data are reproduced in the information processing system 10 according to the seventh example embodiment, first, the user information acquisition unit 340 acquires the information about the user who is about to reproduce the audio data (i.e., the reproduction user information) (step S711). Then, the user determination unit 260 determines whether or not the reproduction user information acquired by the user information acquisition unit 340 matches the specific user information stored in the specific user information storage unit 250 (step S712).

When the reproduction user information matches the specific user information (the step S712: YES), the user determination unit 160 determines that the reproduction is performed by the specific user (step S713). On the other hand, when the reproduction user information does not match the specific user information (the step S712: NO), the user determination unit 160 determines that the reproduction is performed by the user other than the specific user (step S714).

After the above determination, the reproduction processing is performed on the audio data (step S715). In a case where the user who performs the reproduction is not the specific user, the audio data may not be reproduced. Alternatively, in a case where the user who performs the reproduction is not the specific user, only a part of the audio may be reproduced. Alternatively, in a case where the user who performs the reproduction is not the specific user, an alert may be outputted. Furthermore, regardless of whether or not the user who performs the reproduction is the specific user, the audio data may be reproduced. In this case, however, a history of reproduction by the user other than the specific user is preferably recorded.

In a case where the audio data include a will, the audio data may be stored/kept with text data on the will. In this case, processing of comparing the content of the audio data with the content of the text data may be performed, for example, at a timing of generating or reproducing the audio data. Then, in a case where there is a difference or shortage in the content, the user may be notified of the fact.

### Technical Effect

Next, a technical effect obtained by the information processing system 10 according to the seventh example embodiment will be described.

As described in FIG. 19 to FIG. 21, in the information processing system 10 according to the seventh example embodiment, it is determined whether or not the audio data are reproduced by the specific user. In this way, it is possible to prevent that the audio data are reproduced in an unauthorized manner by a user who does not have the right to reproduce the audio data. Alternatively, even in a case where the audio data are reproduced in an unauthorized manner, the fact can be grasped in subsequent verification.

### Eighth Example Embodiment

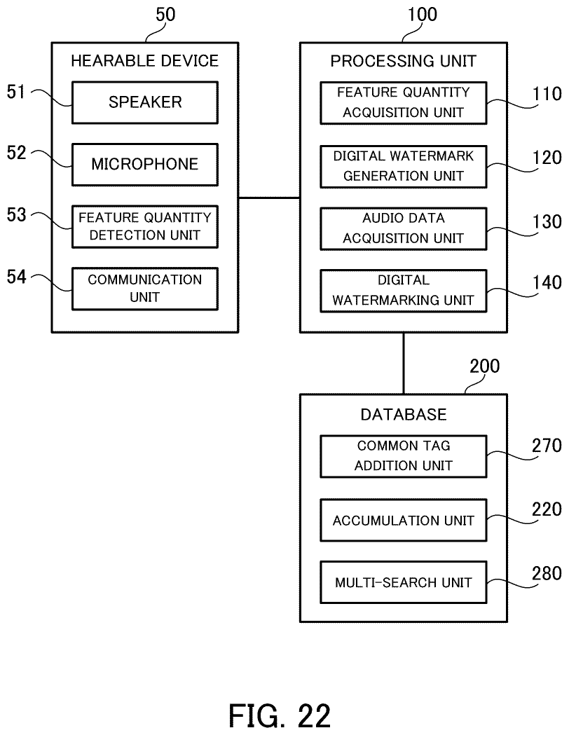

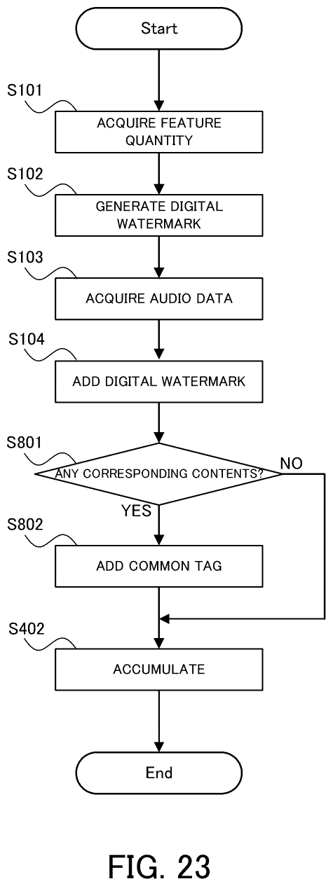

The information processing system 10 according to an eighth example embodiment will be described with reference to FIG. 22 and FIG. 23. The eighth example embodiment is partially different from the first to seventh example embodiments only in the configuration and operation, and may be the same as the first to seventh example embodiments in the other parts. For this reason, a part that is different from each of the example embodiments described above will be described in detail below, and a description of the other overlapping parts will be omitted as appropriate.

### Functional Configuration

First, with reference to FIG. 22, a functional configuration of the information processing system 10 according to the eighth example embodiment will be described. FIG. 22 is a block diagram illustrating the functional configuration of the information processing system according to the eighth example embodiment. In FIG. 22, the same components as those illustrated in FIG. 11 carry the same reference numerals.

As illustrated in FIG. 22, the information processing system 10 according to the eighth example embodiment includes the hearable device 50, the processing unit 100, and the database 200.

The database 200 according to the eighth example embodiment includes, as components for realizing the functions thereof, the accumulation unit 220, a common tag addition unit 270, and a multi-search unit 280. That is, the database 200 according to the eighth example embodiment includes the common tag addition unit 270 and the multi-search unit 280, instead of the search information addition unit 210 and the extraction unit 230 in the database 200 according to the fourth example embodiment (see FIG. 11). The database 200 according to the eighth example embodiment may include the search information assigning unit 210 and the extraction unit 230, in addition to the common tag addition unit 270 and the multi-search unit 280 (i.e., may have the same search function as in the fourth example embodiment).

The common tag addition unit 270 is configured to add a common tag to the audio data to which the digital watermark is added, and to other content data corresponding to the audio data. For example, a tag indicating a common speaker (in this case, a tag of “Mr. A”) may be added to data including the same speaker (e.g., “audio data” and “video data” when Mr. A is speaking). Alternatively, a tag indicating a common place (here, “◯◯ meeting”) may be added to data acquired at the same place (e.g., “Mr. B audio data” and “Mr. C audio data” when Mr. B and Mr. C are talking at a meeting). The common tag may be added to three or more pieces of data.

The multi-search unit 280 is configured to simultaneously search for data to which the common tag is added, by using the tag added by the common tag addition unit. For example, it is configured to search for corresponding multiple pieces of data, by inputting only one search query. A search target of the multi-search unit 280 may be various types of data. Even if the search target is various types of data, it is possible to search for the various types of data simultaneously by using the same tag added to them.

### Flow of Operation

Next, with reference to FIG. 23, a flow of operation of the information processing system 10 according to the eighth example embodiment (especially, operation until the audio data are accumulated) will be described. FIG. 23 is a flowchart illustrating the flow of the operation by the information processing system according to the eighth example embodiment. In FIG. 23, the same steps as those illustrated in FIG. 12 carry the same reference numerals.

As illustrated in FIG. 23, when the operation by the information processing system 10 according to the eighth example embodiment is started, first, the feature quantity acquisition unit 110 acquires the feature quantity of the ear canal of the target detected by the feature quantity detection unit 53 in the hearable device 50 (step S101). Thereafter, the digital watermark generation unit 120 generates the digital watermark from the feature quantity of the ear canal of the target acquired by the feature quantity acquisition unit 110 (step S102).

Subsequently, the audio data acquisition unit 130 acquires the audio data including the speech of the target (step S103). Then, the digital watermarking unit 140 adds the digital watermark generated by the digital watermark generation unit 120 to the audio data acquired by the audio data acquisition unit 130 (step S104).

Subsequently, it is determined whether or not the content data corresponding to the audio data to which the digital watermark is added, are accumulated (step S801). This determination may be performed automatically by analyzing each piece of data, or may be performed manually, for example.

Then, when there are the corresponding content data (the step S801: YES), the common tag addition unit 270 adds the common tag to the audio data to which the digital watermark is added, and to the corresponding content data (step S802). When there are no corresponding content data (the step S801: NO), the step S802 may be omitted.

Then, the accumulation unit 220 accumulates the audio data to which the digital watermark is added (step S402). The common tag addition unit 270 may add the common tag after the audio data are accumulated in the accumulation unit 220. That is, the step S801 and the step S802 may be performed after the step S402.

### Technical Effect

Next, a technical effect obtained by the information processing system 10 according to the eighth example embodiment will be described.

As described in FIG. 22 and FIG. 23, in the information processing system 10 according to the eighth example embodiment, the tag common to a plurality of corresponding contents is added. In this way, multi-search can be performed by using the common tag as the search query. Thus, for example, even when voice/sound/audio and video at the same place are accumulated as separate pieces of data, it is possible to properly search for corresponding each piece of data.

In each of the above example embodiments, the audio data are described as an example; however, not only the audio data, but also the video data can be set as the target by linking the hearable device 50 with the camera, for example. In addition, it is possible to target the audio data from a stereo or the like, by linking the hearable device 50 with another microphone. Furthermore, a place of the speech may also be proven by the hearable device 50 using information from a GPS (Global Positioning System).

The information processing system 10 according to each example embodiment may also be used as a system that records statements in a court, statements in a commercial transaction, a speech of a president, statements of a politician, or the like, for example. It is also available not only to store statements of one target, but also to store statements of a plurality of people (e.g., on-line meeting minutes, etc.). In a case where those who wear the hearable device 50 have conversation with each other, it is possible to handle the audio data in which speeches of a plurality of people are mixed, and it is thus possible to prove the conversation itself. It is also possible to synchronize a plurality of pieces of audio data, on the basis of the time information authenticated by the timestamp.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes a processing alone, but also the program that operates on an OS and that executes a processing in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes below.

### Supplementary Note 1

An information processing system according to Supplementary Note 1 is an information processing system including: a feature quantity acquisition unit that acquires biometric information about a target; a watermark generation unit that generates a digital watermark on the basis of the biometric information; an audio acquisition unit that acquires audio data including speech of the target; and a watermarking unit that adds the digital watermark to the audio data.

### Supplementary Note 2

An information processing system according to Supplementary Note 2 is the information processing system according to Supplementary Note 1, wherein the audio acquisition unit acquires first audio data from a first terminal corresponding to a first target and acquires second audio data from a second terminal corresponding to a second target who accompanies the first target, and the watermarking unit adds the digital watermark based on the biometric information acquired from at least one of the first target and the second target, to synthesized audio data obtained by synthesizing the first audio data and the second audio data.

### Supplementary Note 3

An information processing system according to Supplementary Note 3 is the information processing system according to Supplementary Note 1 or 2, further including: a biometric authentication unit that performs biometric authentication on the target at a plurality of times during recording of the audio data; and a history storage unit that stores a result history of the biometric authentication at the plurality of times.

### Supplementary Note 4

An information processing system according to Supplementary Note 4 is the information processing system according to any one of Supplementary Notes 1 to 3, further including: an audio data accumulation unit that accumulates the audio data to which the digital watermark is added, in association with at least one of a keyword included in speech content, information about the target, and a date and time of the speech; and an extraction unit that extracts the audio data matching a search query from a plurality of pieces of audio data accumulated in the audio data accumulation unit, by using the search query including at least one of a keyword included in speech content, information about the target, and a date and time of the speech.

### Supplementary Note 5

An information processing system according to Supplementary Note 5 is the information processing system according to Supplementary Note 4, further including a first display unit that displays a seek bar in a display aspect in which a part matching the search query in the audio data can be visually recognized, when the audio data extracted by the extraction unit are reproduced.

### Supplementary Note 6

An information processing system according to Supplementary Note 6 is the information processing system according to any one of Supplementary Notes 1 to 5, further including a second display unit that displays a seek bar in a display aspect in which a part reproduced many times in the audio data can be visually recognized, when the audio data to which the digital watermark is added, are reproduced.

### Supplementary Note 7

An information processing system according to Supplementary Note 7 is the information processing system according to any one of Supplementary Notes 1 to 6, further including: a specific user information storage unit that stores information about a specific user who is a user different from the target and who is permitted to reproduce the audio data to which the digital watermark is added; and a determination unit that determines whether or not the audio data are reproduced by the specific user, on the basis of the information about the specific user stored in the specific user information storage unit.

### Supplementary Note 8

An information processing system according to Supplementary Note 8 is the information processing system according to any one of Supplementary Notes 1 to 7, further including: a tag addition unit that adds a common tag to the audio data to which the digital watermark is added, and to other content data corresponding to the audio data; and a search unit that simultaneously searches for the audio data and the other content data by using the tag.

### Supplementary Note 9

An information processing method according to Supplementary Note 9 is an information processing method that is executed by at least one computer, the information processing method including: acquiring biometric information about a target; generating a digital watermark on the basis of the biometric information; acquiring audio data including speech of the target; and adding the digital watermark to the audio data.

### Supplementary Note 10

A recording medium according to Supplementary Note 10 is a recording medium on which a computer program that allows at least one computer to execute an information processing method is recorded, the information processing method including: acquiring biometric information about a target; generating a digital watermark on the basis of the biometric information; acquiring audio data including speech of the target; and adding the digital watermark to the audio data.

### Supplementary Note 11

A computer program according to Supplementary Note 11 is a computer program that allows at least one computer to execute an information processing method, the information processing method including: acquiring biometric information about a target; generating a digital watermark on the basis of the biometric information; acquiring audio data including speech of the target; and adding the digital watermark to the audio data.

### Supplementary Note 12

An information processing apparatus according to Supplementary Note 12 is an information processing apparatus including: a feature quantity acquisition unit that acquires biometric information about a target; a watermark generation unit that generates a digital watermark on the basis of the biometric information; an audio acquisition unit that acquires audio data including speech of the target; and a watermarking unit that adds the digital watermark to the audio data.

### Supplementary Note 13

A data structure according to Supplementary Note 13 is a data structure of audio data acquired by an audio device, the data structure including: metadata including personal information about a speaker of the audio data and time information about data creation; speech information about speech content of the speaker; biometric authentication information indicating that authentication is performed by using biometric information about the speaker in the audio device; device information about the audio device; a timestamp created on the basis of the metadata, the speech information, the biometric authentication information, and the device information; and an electronic signature created on the basis of the metadata, the speech information, the biometric authentication information, the device information, and the timestamp.

This disclosure is allowed to be changed, if desired, without departing from the essence or spirit of this disclosure which can be read from the claims and the entire specification. An information processing system, an information processing method, a recording medium, and a data structure with such changes are also intended to be within the technical scope of this disclosure.

### DESCRIPTION OF REFERENCE CODES

10 Information processing system
11 Processor
14 Storage apparatus
15 Input apparatus
16 Output apparatus
50 Hearable device
51 Speaker
52 Microphone
53 Feature quantity detection unit
54 Communication unit
100 Processing unit
110 Feature quantity acquisition unit
120 Digital watermark generation unit
130 Audio data acquisition unit
140 Digital watermarking unit
200 Database
210 Search information addition unit
220 Accumulation unit
230 Extraction unit
240 Reproduction number management unit
250 Specific user information storage unit
260 User determination unit
270 Common tag addition unit
280 Multi-search unit
300 Reproduction apparatus
310 Speaker
320 First display unit
330 Second display unit
340 User information acquisition unit
D1 Metadata
D2 Speech data
D3 Biometric authentication certificate
D4 Device certificate
D5 Timestamp
D6 Entire electronic signature

What is claimed is:

1. An information processing system comprising:
at least one memory that is configured to store instructions; and
at least one processor that is configured to execute the instructions to:
acquire biometric information about a target;
generate a digital watermark on the basis of the biometric information;
acquire audio data including speech of the target; and
add the digital watermark to the audio data.

2. The information processing system according to claim 1, wherein the at least one processor is configured to execute the instructions to:
acquire first audio data from a first terminal corresponding to a first target and acquire second audio data from a second terminal corresponding to a second target who accompanies the first target, and
add the digital watermark based on the biometric information acquired from at least one of the first target and the second target, to synthesized audio data obtained by synthesizing the first audio data and the second audio data.

3. The information processing system according to claim 1, wherein the at least one processor is configured to execute the instructions to:
perform biometric authentication on the target at a plurality of times during recording of the audio data; and
store a result history of the biometric authentication at the plurality of times.

4. The information processing system according to claim 1, wherein the at least one processor is configured to execute the instructions to:
accumulate the audio data to which the digital watermark is added, in association with at least one of a keyword included in speech content, information about the target, and a date and time of the speech; and
extract the audio data matching a search query from a plurality of pieces of audio data accumulated, by using the search query including at least one of a keyword included in speech content, information about the target, and a date and time of the speech.

5. The information processing system according to claim 4, wherein the at least one processor is configured to execute the instructions to display a seek bar in a display aspect in which a part matching the search query in the audio data can be visually recognized, when the audio data extracted are reproduced.

6. The information processing system according to claim 1, wherein the at least one processor is configured to execute the instructions to display a seek bar in a display aspect in which a part reproduced many times in the audio data can be visually recognized, when the audio data to which the digital watermark is added, are reproduced.

7. The information processing system according to claim 1, wherein the at least one processor is configured to execute the instructions to:
store information about a specific user who is a user different from the target and who is permitted to reproduce the audio data to which the digital watermark is added; and
determine whether or not the audio data are reproduced by the specific user, on the basis of the information about the specific user stored.

8. The information processing system according to claim 1, wherein the at least one processor is configured to execute the instructions to:
add a common tag to the audio data to which the digital watermark is added, and to other content data corresponding to the audio data; and
simultaneously search for the audio data and the other content data by using the tag.

9. An information processing method that is executed by at least one computer, the information processing method comprising:
acquiring biometric information about a target;
generating a digital watermark on the basis of the biometric information;
acquiring audio data including speech of the target; and
adding the digital watermark to the audio data.

10. A non-transitory recording medium on which a computer program that allows at least one computer to execute an information processing method is recorded, the information processing method including:
acquiring biometric information about a target;
generating a digital watermark on the basis of the biometric information;
acquiring audio data including speech of the target; and
adding the digital watermark to the audio data.

11. (canceled)
